(19) United States
(12) Patent Application Publication
(10) Pub. No.: US 2025/0087190 A1
(43) Pub. Date: Mar. 13, 2025

(54) Sound Control Device, Electronic Musical Instrument, Method of Controlling Sound Control Device, and Non-Transitory Computer-Readable Storage Medium

(71) Applicant: YAMAHA CORPORATION, Hamamatsu-shi (JP)

(72) Inventor: Tatsuya IRIYAMA, Hamamatsu-shi (JP)

(21) Appl. No.: 18/953,436

(22) Filed: Nov. 20, 2024

Related U.S. Application Data
(63) Continuation of application No. PCT/JP2023/015804, filed on Apr. 20, 2023.

(30) Foreign Application Priority Data
May 31, 2022 (JP) 2022-088561

(51) Int. Cl. G10H 1/36; G10H 1/00

(52) U.S. Cl. CPC G10H 1/366; G10H 1/0008; G10H 2210/005; G10H 2210/051; G10H 2210/076; G10H 2210/375; G10H 2220/361

(57) ABSTRACT

A sound control device includes an obtainer, a determiner, an identifier, and an instructor. The obtainer obtains performance information. The determiner identifies a note-on or a note-off based on the performance information. The identifier identifies, from lyrics data, a syllable corresponding to a timing at which the determiner identified the note-on. The lyrics data includes a chronological arrangement of a plurality of syllables to be pronounced. The instructor instructs the syllable identified by the identifier to start being pronounced at a timing corresponding to the note-on, and causes at least one phoneme among phonemes constituting the identified syllable to start being pronounced at a timing corresponding to the note-off.

### CROSS-REFERENCE TO RELATED APPLICATIONS

The present application is a continuation application of International Application No. PCT/JP2023/015804, filed Apr. 20, 2023, which claims priority to Japanese Patent Application No. 2022-088561, filed May 31, 2022. The contents of these applications are incorporated herein by reference in their entirety.

The present disclosure relates to a sound control device, an electronic musical instrument, a method of controlling a sound control device, and a non-transitory computer-readable storage medium.

Musical instruments and similar sound control devices generate electronic sounds that simulate musical instrument sounds. Such musical instruments also generate synthesized singing voices by synthesizing vocal sounds. JP2016-206496A, JP2014-98801A, and JP7036141B disclose technology for generating synthesized singing voices in real-time based on performance operations.

In a performance operation, a note-on operation causes sound generation to start, and a note-off operation causes the sound generation to end. For some syllables being pronounced, however, this performance operation alone may not align with a performer's intent. For example, sufficient consideration has not been given to sound generation (pronunciation) control of a syllable based on a note-off. Thus, there was room for improvement in ensuring that syllables are pronounced in alignment with the performer's intent.

One object of the present invention is to provide a sound control device that enables a syllable to be pronounced as intended by a performer.

### SUMMARY

One aspect is a sound control device that includes an obtainer, a determiner, an identifier, and an instructor. The obtainer is configured to obtain performance information. The determiner is configured to identify a note-on or a note-off based on the performance information. The identifier is configured to identify, from lyrics data, a syllable corresponding to a timing at which the determiner identified the note-on. The lyrics data includes a chronological arrangement of a plurality of syllables to be pronounced. The instructor is configured to cause the syllable identified by the identifier to start being pronounced at a timing corresponding to the note-on, and configured to cause at least one phoneme among phonemes constituting the identified syllable to start being pronounced at a timing corresponding to the note-off.

Another aspect is an electronic musical instrument that includes the above-described sound control device and a musical performance operation section for a user to input the performance information into the sound control device.

Another aspect is a computer-implemented method of controlling a sound control device. The method includes obtaining performance information. The method also includes identifying a note-on or a note-off based on the performance information. The method also includes identifying, from lyrics data, a syllable corresponding to a timing of identifying of the note-on. The lyrics data includes a chronological arrangement of a plurality of syllables to be pronounced. The method also includes causing the identified syllable to start being pronounced at a timing corresponding to the note-on, and causing at least one phoneme among phonemes constituting the identified syllable to start being pronounced at a timing corresponding to the note-off.

Another aspect is a non-transitory computer-readable storage medium a non-transitory computer-readable storage medium storing a program. When the program is executed by at least one processor, the program causes the at least one processor to obtain performance information. The program also causes the at least one processor to identify a note-on or a note-off based on the performance information. The program also causes the at least one processor to identify, from lyrics data, a syllable corresponding to a timing of identifying of the note-on. The lyrics data includes a chronological arrangement of a plurality of syllables to be pronounced. The program also causes the at least one processor to cause the identified syllable to start being pronounced at a timing corresponding to the note-on, and cause at least one phoneme among phonemes constituting the identified syllable to start being pronounced at a timing corresponding to the note-off.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a block diagram of a sound control system that includes a sound control device;

FIG. 2 is a schematic illustration of lyrics data;

FIG. 3 is a functional block diagram of the sound control device;

FIG. 4 is a timing chart of an example of sound control performed based on a performance signal;

FIG. 5 is a flowchart of sound control processing;

FIG. 6 is a flowchart of instruction processing;

FIG. 7 is a flowchart of English-language processing;

FIG. 8 is a flowchart of Japanese-language processing;

FIG. 9 is a timing chart of an example of sound control according to an embodiment; and

FIG. 10 is a flowchart of English-language processing.

### DESCRIPTION OF THE EMBODIMENTS

The present specification is applicable to a sound control device, an electronic musical instrument, a method of controlling a sound control device, and a non-transitory computer-readable storage medium.

The embodiments will now be described with reference to the accompanying drawings, wherein like reference numerals designate corresponding or identical elements throughout the various drawings. The embodiments presented below serve as illustrative examples of the present disclosure and are not intended to limit the scope of the present disclosure.

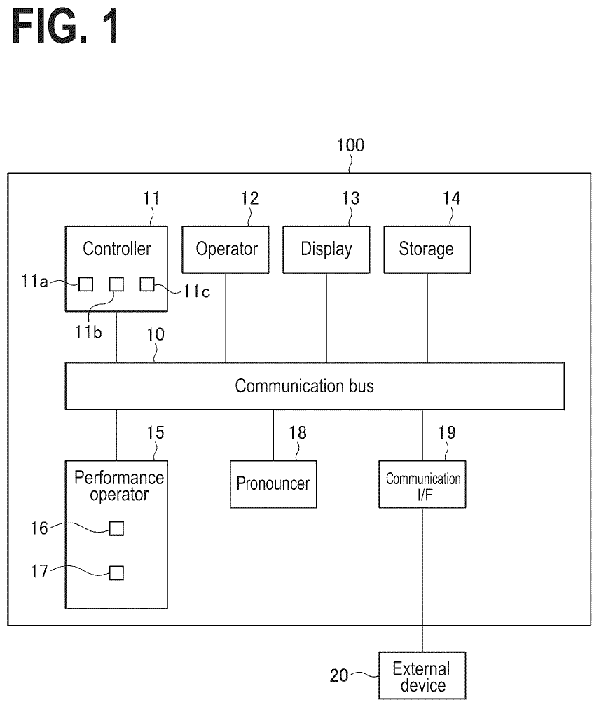

FIG. 1 is a block diagram of a sound control system that includes a sound control device according to this embodiment. The sound control system includes a sound control device 100 and an external device 20. An example of the sound control device 100 is an electronic musical instrument. For example, the electronic musical instrument may be an electronic wind instrument such as a saxophone.

The sound control device 100 includes a controller 11, an operation section 12, a display 13, a storage 14, a performance operation section 15, a pronouncer 18, and a communication I/F (interface) 19. These elements are connected to each other via a communication bus 10.

The controller 11 includes a CPU 11a, a ROM 11b, a RAM 11c, and a timer (not illustrated). The ROM 11b stores a control program executed by the CPU 11a. The CPU 11a implements various functions of the sound control device 100 by developing, in the RAM 11c, the control program stored in the ROM 11b and executing the developed control program.

The controller 11 includes a DSP (Digital Signal Processor) for generating an audio signal. The storage 14 is a nonvolatile memory. The storage 14 stores setting information used at the time of generating an audio signal indicating synthesized singing sound. The storage 14 also stores synthesis units (which can also be referred to as phonemes or speech elements) for generating synthesized vocal sound. The setting information includes, for example, tones and lyrics data that has been obtained.

The operation section 12 includes a plurality of operation pieces through which various kinds of information are input. Thus, the operation section 12 receives instructions from a user. The display 13 displays various kinds of information. The pronouncer 18 includes a sound source circuit, an effect circuit, and a sound system.

the performance operation section 15 includes a plurality of operation keys 16 and a breath sensor 17. The plurality of operation keys 16 and the breath sensor 17 are elements to input performance signals ((musical) performance information). An input performance signal includes sound pitch information and sound volume information. The sound pitch information indicates sound pitch. The sound volume information indicates sound volume detected as a continuous quantity. The input performance signal is supplied to the controller 11. The sound control device 100 has a plurality of tone holes (not illustrated) on the body of the sound control device 100. By pressing the plurality of operation keys 16, the user (performer) changes the opening and closing states of the tone holes to specify a desired sound pitch.

A mouthpiece (not illustrated) is mounted on the body of the sound control device 100, and the breath sensor 17 is provided near the mouthpiece. The breath sensor 17 is a pressure sensor that detects the blowing pressure of the air introduced by the user through the mouthpiece. The breath sensor 17 detects the presence or absence of air blown and, during performance, measures the strength and speed (force) of the blowing pressure. The sound volume is determined in accordance with the changes in pressure detected by the breath sensor 17. The magnitude of the time-varying pressure detected by the breath sensor 17 is treated as volume information, which is detected as a continuous quantity.

The communication I/F 19 is connected to a communication network in a wireless or wired manner. At the communication I/F 19, the sound control device 100 is communicably connected to the external device 20 through the communication network. An example of the communication network is the Internet, and the external device 20 may be a server device. The communication network, alternatively, may be a Bluetooth (registered trademark) network, an infrared communication network, or a short-range wireless communication network using a local area network (LAN). It is to be noted that there is no particular limitation to the number and kinds of external devices connected to the sound control device 100. The communication I/F 19 may include a MIDI I/F that transmits and receives a MIDI (Musical Instrument Digital Interface) signal.

The external device 20 stores music piece data necessary for providing karaoke in such a manner that each music piece datum is linked to a music piece ID. The each music piece datum includes data related to a karaoke song, examples including lead vocal data, chorus data, accompaniment data, and karaoke caption (subtitle) data. The accompaniment data is data indicating sound that accompanies the song. The lead vocal data, chorus data, and accompaniment data may be data represented in MIDI form. The karaoke caption data is data for displaying lyrics on the display 13.

The external device 20 also stores setting data in such a manner that each setting datum is linked to a music piece ID. The setting data includes information input into the sound control device 100 for each song individually to synthesize singing sound. A song associated with a music piece ID is segmented into parts, with the setting data including lyrics data corresponding to each part. An example of the lyrics data is lyrics data corresponding to a lead vocal part among the parts. The music piece data and the setting data are linked to each other temporally.

The lyrics data may be the same as or different from the karaoke caption data. That is, while the lyrics data is similar to the karaoke caption data in that the lyrics data defines lyrics (characters) to be pronounced as sound, the lyrics data is adjusted for better use in the sound control device 100.

For example, the karaoke caption data consists of the character string “ko”, “n”, “ni”, “chi”, “ha”. The lyrics data, in contrast, may be the character string “ko”, “n”, “ni”, “chi”, “wa”, which more closely matches actual sound emission and is optimized for use in the sound control device 100. This form of data may include information identifying a single segment of singing sound corresponding to two characters, and/or information identifying a phrase segmentation.

In performing sound control processing, the controller 11 obtains, from the external device 20 via the communication I/F 19, music piece data and setting data specified by the user. Then, the controller 11 stores the music piece data and the setting data in the storage 14. As described above, the music piece data includes accompaniment data, and the setting data includes lyrics data. Also as described above, the accompaniment data and the lyrics data are linked to each other temporally.

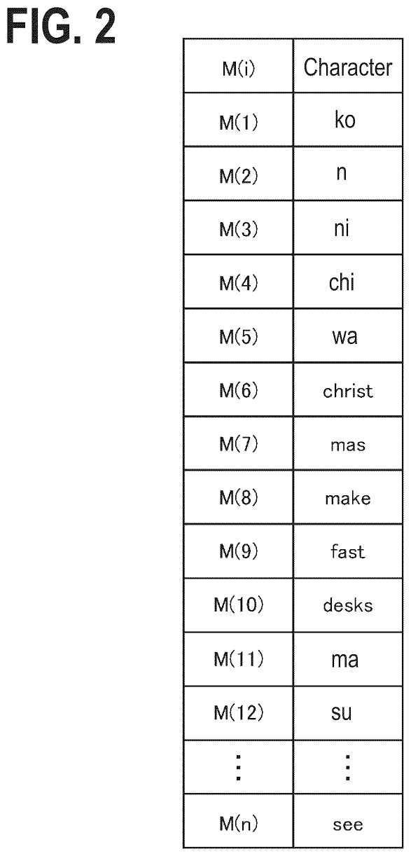

FIG. 2 is a schematic illustration of lyrics data. In the following description, each of the lyrics (characters) to be pronounced as sound may occasionally be referred to as “syllable”. More specifically, the term syllable is intended to mean one unit of sound (one segment of sound). The lyrics data is data that specifies a syllable to be pronounced as sound. The lyrics data includes text data in which a plurality of syllables to be pronounced as sound are arranged in chronological order. The plurality of syllables to be pronounced are identified in order based on a performance's progression. Thus, the characters M(i)=M(1) to M(n) in the lyrics data illustrated in FIG. 2 are pronounced as sound in order.

As illustrated in FIG. 2, the lyrics data includes text data indicating “ko”, “n”, “ni”, “chi”, “wa”, “christ”, “mas”, “make”, “fast”, “desks”, “ma”, “su” . . . “see”. Each of the syllables (“ko”, “n”, “ni”, “chi”, “wa”, “christ”, “mas”, “make”, “fast”, “desks”, “ma”, “su” . . . “see”) is linked to M(i) where “i” (i=1 to n) specifies the order of the corresponding syllable in the lyrics. For example, M(5) corresponds to the fifth syllable in the lyrics. As described below, the pronunciation period of each syllable included in the synthesized singing sound is controlled based on the performance information.

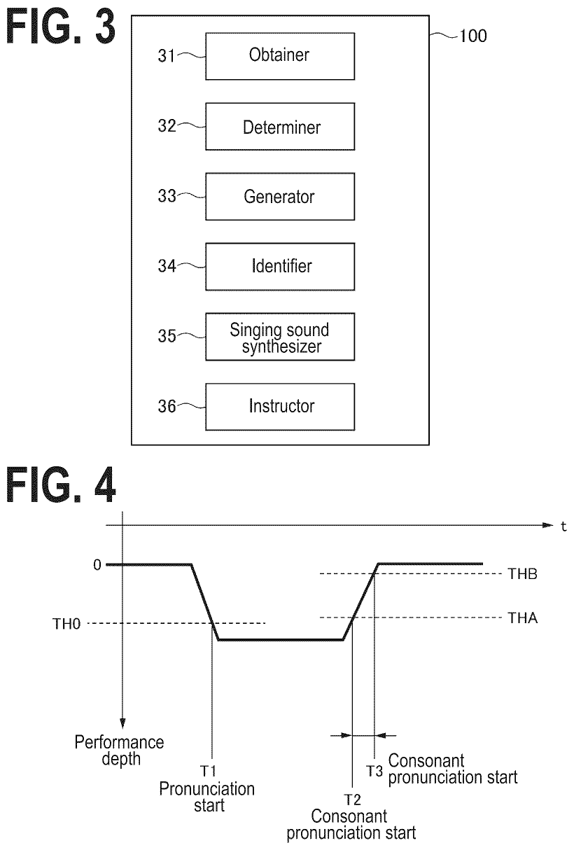

FIG. 3 is a functional block diagram of the sound control device 100 for performing sound generation processing. The sound control device 100 includes functional sections, namely, an obtainer 31, a determiner 32, a generator 33, an identifier 34, a singing sound synthesizer 35, and an instructor 36. The functions of these functional sections are implemented through the collaborative operation of the CPU 11a, the ROM 11b, the RAM 11c, the timer, and the communication I/F 19. It is to be noted that the generator 33 and the singing sound synthesizer 35 may not necessarily be included.

The obtainer 31 obtains a performance signal. The determiner 32 compares a performance signal with a threshold. Then, based on the result of the comparison, the determiner 32 determines whether a note-on (note start) or a note-off (note end) has occurred (identifies a note-on or a note-off). The generator 33 generates a note based on the identified note-on or note-off. The identifier 34 identifies, from the lyrics data, a syllable corresponding to a timing at which the determiner 32 identified the note-on.

The singing sound synthesizer 35 synthesizes the identified syllable based on the setting data to generate vocal sound. The instructor 36 causes the singing sound of the identified syllable to start being pronounced at a timing and a sound pitch corresponding to the note-on. The instructor 36 also causes the singing sound of the identified syllable to end being pronounced at a timing corresponding to the note-off. Based on the instruction made by the instructor 36, the syllable-synthesized singing sound is pronounced by the pronouncer 18 (FIG. 1).

It is to be noted that the instructor 36 causes at least one phoneme among phonemes constituting the identified syllable to start being pronounced at the timing corresponding to the note-off, instead of the note-on. An example of sound generation control of at least one phoneme among the phonemes constituting the identified syllable will be described later by referring to FIG. 4.

Next, a manner in which the sound generation processing is performed will be outlined. Lyrics data and accompaniment data that correspond to a music piece specified by the user are stored in the storage 14. When the user instructs to start a performance on the operation section 12, reproduction of the accompaniment data starts. That is, the pronouncer 18 pronounces a sound based on the accompaniment data. Upon start of reproduction of the accompaniment data, the lyrics from the lyrics data (or the karaoke caption data) are displayed on the display 13 in synchronization with the accompaniment data's progression. It is to be noted that the setting data may include musical score data. In this case, a musical score of a main melody that is based on the lead vocal data may be displayed on the display 13 in synchronization with the accompaniment data's progression. The user plays a performance on the performance operation section 15 while listening to the accompaniment data. The obtainer 31 obtains a performance signal in synchronization with the performance's progression. It is to be noted that the accompaniment data may not necessarily be reproduced.

FIG. 4 is a timing chart of an example of sound control performed based on a performance signal.

In FIG. 4, the horizontal axis of the timing chart represents time t, while the vertical axis represents the “performance depth” indicated by the performance signal. The larger the detected value from the breath sensor 17, the stronger the blowing pressure, resulting in a deeper (musical) performance depth. During non-performance time, the blowing pressure is “0”. The volume information is defined based on the performance depth.

Thresholds against which the performance depth is compared are pronunciation threshold TH0 and mute control thresholds, namely, a first threshold THA and a second threshold THB. The performance depth of the second threshold THB is shallower (narrower) than the performance depth of the first threshold THA. There is no particular limitation to the relative magnitude between the pronunciation threshold TH0 and the mute control thresholds THA and THB. In the example illustrated in FIG. 4, the performance depth of the pronunciation threshold TH0 is greater than the performance depth of the first threshold THA. It is to be noted that the second threshold THB may be identical to “0”.

In the example illustrated in FIG. 4, the performance depth increases from non-performance state to a depth greater than the pronunciation threshold TH0. Then, the performance depth decreases to cross (pass) the mute control thresholds THA and THB in this order, and returns to the non-performance state. The time at which the performance depth increases to cross the pronunciation threshold TH0 will be referred to as T1. The time at which the performance depth decreases to cross the first threshold THA will be referred to as T2. The time at which the performance depth decreases to cross the second threshold THB will be referred to as T3.

At the time T1, the controller 11 identifies a syllable to be pronounced and causes the syllable to start being pronounced. In this context, the controller 11 performs the sound control differently depending on whether the identified syllable includes a consonant at the end of the identified syllable or the identified syllable includes no consonant at the end of the identified syllable. In the following description, a syllable with a consonant (end consonant) at the end of the syllable will be referred to as “special syllable”, and a syllable without a consonant at the end of the syllable will be referred to as “non-special syllable”.

For example, in a case of a non-special syllable “see [si]”, the controller 11 performs the following sound control. In “see [si]”, [si] is a phonetic notation. At the time T1, the controller 11 causes [si] to start being pronounced. At the time T3, the controller 11 causes [si] to end being pronounced.

In contrast with the non-special syllable “see [si]”, a special syllable “mas [ma][s]” includes consonant [s] at the end of the special syllable. In this case, at the time T1, the controller 11 causes a beginning phoneme [ma] of the special syllable “mas” to start being pronounced. The beginning phoneme [ma] is at the beginning of the special syllable “mas”. Then, at the time T2, the controller 11 causes the beginning phoneme [ma] to end being pronounced. Also at the time T2, the controller 11 causes the remaining phoneme [s], which is equivalent to the end consonant, to start being pronounced (consonant pronunciation start). At the time T3, the controller 11 causes the remaining phoneme [s] to end being pronounced.

Thus, the pronunciation continuation time for which the beginning phoneme [ma] is continuously pronounced is the time from T1 to T2, and the pronunciation continuation time of the remaining phoneme [s] (consonant pronunciation time) is the time from T2 to T3. In this respect, the change in the performance depth for the time from T2 to T3 indicates the degree of temporal change in the performance depth. Therefore, the change in the performance depth for the time from T2 to T3 substantially corresponds to note-off velocity in a performance. Therefore, by increasing or decreasing the speed of the user's operation of decreasing the performance depth, the remaining phoneme [s] can be pronounced for a shorter or longer duration. When the syllable “mas” is pronounced by conventional control, there was a possibility of start of pronunciation of the beginning phoneme [ma] upon detection of a note-on, and a possibility of start of pronunciation of the beginning phoneme [ma] upon detection of a note-off. Thus, the pronunciation of the remaining phoneme [s] may possibly be omitted in this conventional control, which could not be said to fully align with the performer's intent. In contrast with this conventional control, this embodiment enables pronunciation control of a syllable based on a note-off. In particular, this embodiment enables the pronunciation of the end consonant to be controlled as intended by the performer.

Next, sound control processing will be described by referring to a flowchart. In the sound control processing, instruction to generate or stop an audio signal corresponding to each syllable is output based on a performance operation using the performance operation section 15.

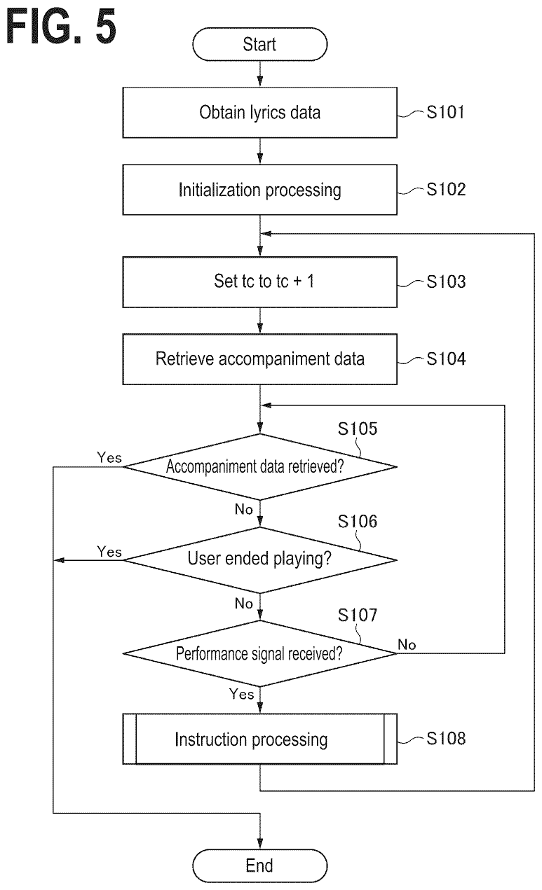

FIG. 5 is a flowchart of the sound control processing. This processing is performed by the CPU 11a developing, in the RAM 11c, the control program stored in the ROM 11b and executing the developed control program. This processing starts at the user's instruction to reproduce a music piece.

At step S101, the controller 11 obtains lyrics data from the storage 14. Next, at step S102, the controller 11 performs initialization processing. In this initialization processing, the controller 11 sets count value to zero (tc=0), and various register values and flags are set to their initial values. Also in this initialization processing, the controller 11 sets character count value i of the character M(i) to 1 (the character M(i)=M(1)). As described above, “i” specifies the order of the corresponding syllable in the lyrics.

Next, at step S103, the controller 11 increases the count value tc by setting the count value tc to “tc+1”. Also at step S103, the controller 11 increases “i” on condition that a pronunciation instruction for the syllable that was identified for the last time is completed at step S108 (described later). By increasing “i”, the controller 11 deals with one syllable M(i) after another in the lyrics. At step S104, the controller 11 retrieves a piece of data corresponding to the count value tc from the accompaniment data.

At step S105, the controller 11 determines whether a piece of data corresponding to the count value tc has been retrieved from the accompaniment data. In a case that the retrieval from the accompaniment data is not ended yet, then at step S106, the controller 11 determines whether the user has input an instruction to end playing of the piece of music. In a case that the user has been input the instruction to end playing of the piece of music, then at step S107, the controller 11 determines whether a performance signal has been received. As used herein, the term performance signal encompasses the fact that the performance depth has passed a threshold. In a case that no performance signal has been received, the controller 11 returns the procedure to step S105.

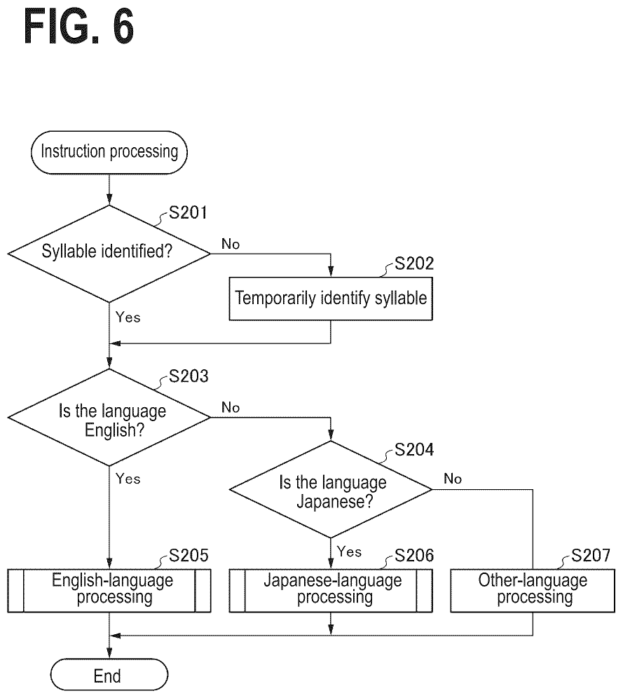

The controller 11 ends the processing illustrated in FIG. 5 in a case that the retrieval from the accompaniment data has ended at step S105 or in a case that the user has input the instruction to end playing of the piece of music at step S106. In a case that the controller 11 has received the performance signal from the performance operation section 15 at step S107, the controller 11 performs instruction processing to generate an audio signal using the DSP (step S108). Details of the instruction processing to generate an audio signal will be described later by referring to FIG. 6. Upon ending of the instruction processing to generate audio signal, the controller 11 returns the procedure to step S103.

FIG. 6 is a flowchart of the instruction processing performed at step S108 illustrated in FIG. 5.

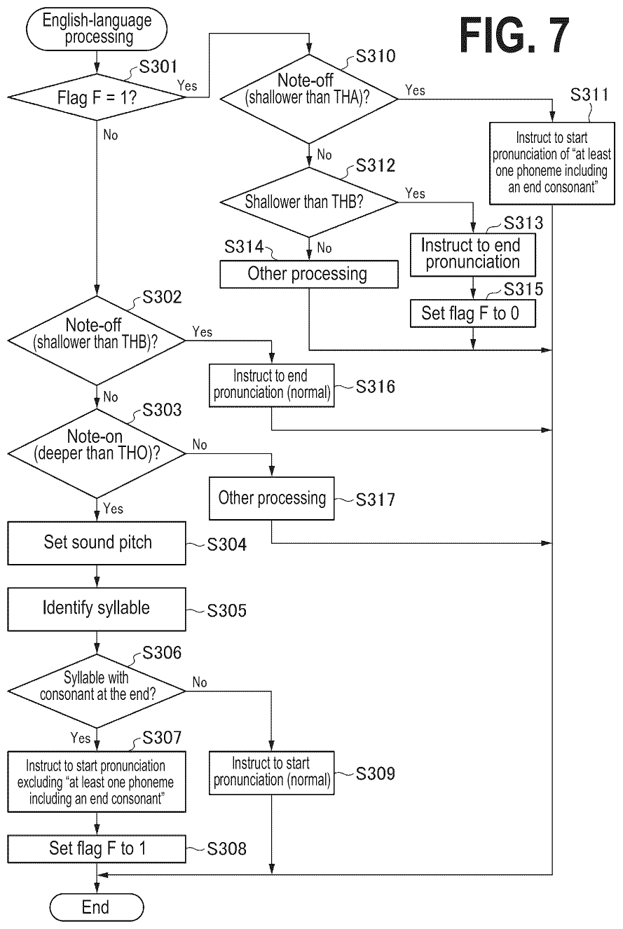

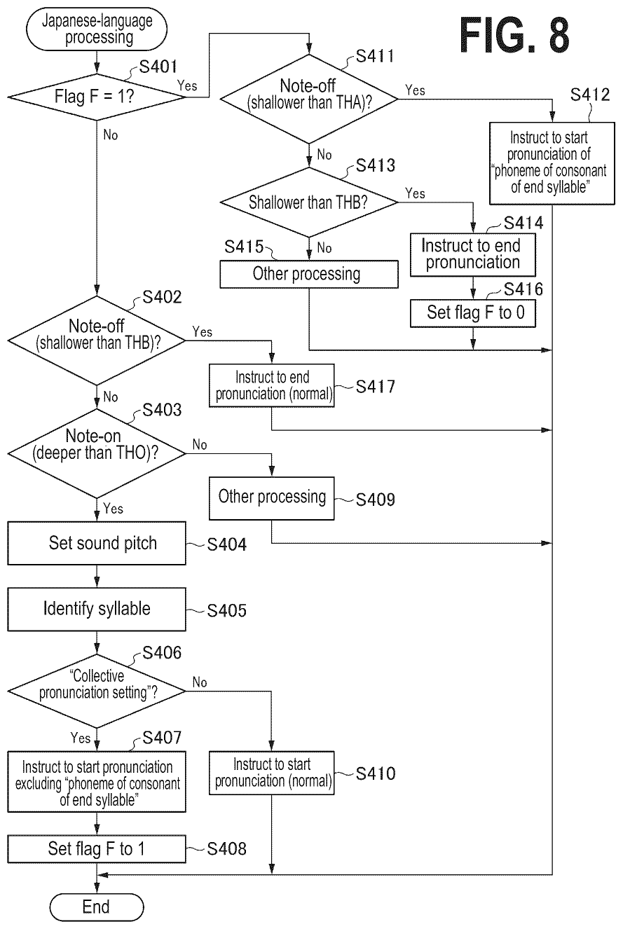

At step S201, the controller 11 determine whether a syllable currently to be pronounced has already been identified. The syllable currently to be pronounced is a syllable corresponding to the timing at which the note-on was identified. The syllable currently to be pronounced is identified at step S305 (described later by referring to FIG. 7) or step S405 (described later by referring to FIG. 8).

In a case that the syllable currently to be pronounced has already been identified, the controller 11 advances the procedure to step S203. In a case that the syllable currently to be pronounced has not been identified yet, the controller 11 advances the procedure to step S202. At step S202, the controller 11 temporarily identifies a syllable currently to be pronounced. As described above, the order in which each syllable to be pronounced is identified is determined by the character count value i. Therefore, the syllable next to the syllable that was pronounced immediately previously is temporarily identified as the syllable currently to be pronounced, excluding the beginning of the piece of music. After step S202, the controller 11 advances the procedure to step S203.

At step S203, the controller 11 identifies the language of the identified syllable, and determines whether the identified language is English. There is no particular limitation to the method of identifying the language; any known method, such as the method recited in JP6553180B, may be employed. The user may predefine a language for each musical piece, each section of a musical piece, or each syllable constituting a musical piece. Then, based on this predefined setting, the controller 11 may determine the language for each syllable.

In a case that the language of the identified syllable is English, the controller 11 advances the procedure to step S205. In a case that the language of the identified syllable is not English, the controller 11 advances the procedure to step S204. At step S205, the controller 11 performs English-language processing (described later by referring to FIG. 7), and ends the processing illustrated in FIG. 6.

At step S204, the controller 11 determines whether the language of the identified syllable is Japanese. The controller 11 uses the above-described method of identifying the language. In a case that the language of the identified syllable is Japanese, the controller 11 advances the procedure to step S206. In a case that the language of the identified syllable is not Japanese, the controller 11 advances the procedure to step S207.

The controller 11 performs Japanese-language processing (described later by referring to FIG. 8) at step S206, and ends the processing illustrated in FIG. 6. At step S207, the controller 11 performs “other-language processing” (not illustrated) corresponding to the language of the identified syllable, and ends the processing illustrated in FIG. 6.

FIG. 7 is a flowchart of the English-language processing performed at step S205 illustrated in FIG. 6. In the English-language processing, the identifier 34 identifies a single syllable for a single note-on.

At step S301, the controller 11 determines whether a flag F is set to “1” (whether the flag F=1). The flag F is a flag indicating that pronunciation of a special syllable has started when the flag is “1”. The flag F is set to “1” at step S308. In a case that the flag F is not “1”, the controller 11 advances the procedure to step S302.

At step S302, the controller 11 determines whether a new note-off has occurred based on the performance depth indicated by the performance signal. Specifically, the controller 11 determines whether the performance depth, which is determined by the detection result obtained by the breath sensor 17, has decreased anew to cross the second threshold THB (whether the time T3 illustrated in FIG. 4 has arrived).

In a case that the controller 11 determines that the performance depth has not decreased anew to cross the second threshold THB, the controller 11 advances the procedure to step S303. At step S303, the controller 11 determines whether a new note-on has occurred based on the performance depth indicated by the performance signal. Specifically, the controller 11 determines whether the performance depth, which is determined by the detection result obtained by the breath sensor 17, has increased anew to cross the pronunciation threshold TH0 (whether the time T1 illustrated in FIG. 4 has arrived).

In a case that the controller 11 determines that no new note-on has occurred, the controller 11 advances the procedure to step S317. At step S317, the controller 11 performs other processing, and ends the processing illustrated in FIG. 7. An example of the “other processing” at step S317 is that while sound is being emitted, the controller 11 outputs an instruction to change the pronunciation volume or the pitch based on a change in the obtained performance depth. In a case that the controller 11 determines that a new note-on has occurred, the controller 11 advances the procedure to step S304.

At step S304, the controller 11 sets the sound pitch indicated by the obtained performance signal. At step S305, the controller 11 identifies a syllable currently to be pronounced in accordance with the order in which the syllables to be pronounced are identified. This syllable is the syllable corresponding to the timing at which the note-on was identified at step S303.

At step S306, the controller 11 determines whether the syllable identified at step S305 is a syllable with a consonant at the end of the syllable (that is, the controller 11 determines whether the syllable identified at step S305 is a special syllable). In a case that the identified syllable is not a special syllable, the controller 11 advances the procedure to step S309.

At step S309, the controller 11 causes the identified syllable to start being pronounced at a timing and a sound pitch corresponding to the current note-on. That is, the controller 11 outputs, to the DSP, a pronunciation start instruction to start generating an audio signal based on the pronunciation of the identified syllable at the set sound pitch. This pronunciation start instruction is an instruction to implement a normal pronunciation. A normal pronunciation continues until a note-off occurs. For example, in a case that the identified syllable is a non-special syllable “see”, [si] is started to be pronounced. Then, the controller 11 ends the processing illustrated in FIG. 7.

In a case that the controller 11 determines that the performance depth has decreased anew to cross the second threshold THB at step S302, the controller 11 advances the procedure to step S316. At step S316, the controller 11 causes the currently identified syllable to end being pronounced at a timing corresponding to the current note-off. For example, in a case that the identified syllable is a syllable “see”, the pronunciation of [si] is ended. Then, the controller 11 ends the processing illustrated in FIG. 7.

In a case that the controller 11 determines that the identified syllable is a special syllable at step S306, the controller 11 advances the procedure to step S307. At step S307, the controller 11 causes the identified syllable to start being pronounced excluding, among the phonemes constituting the identified syllable, “at least one phoneme including an end consonant” at the end of the at least one phoneme. That is, the controller 11 causes the beginning phoneme to start being pronounced, and does not cause the remaining phoneme, among the phonemes, that includes the end consonant to be pronounced. The beginning phoneme is among the phonemes constituting the identified syllable, and is located at the beginning of the identified syllable. For example, in a case that the identified syllable is a special syllable “mas”, the controller 11 causes the beginning phoneme [ma] of the special syllable “mas” to start being pronounced at the time T1 (FIG. 4). However, the controller 11 does not cause the remaining phoneme [s], which is equivalent to the end consonant, to start being pronounced.

At step S308, the controller 11 sets the flag F to “1” (the flag F=1), and the controller 11 ends the processing illustrated in FIG. 7.

In a case that the controller 11 determines that “the flag F=1” at step S301, the controller 11 advances the procedure to step S310. At step S310, the controller 11 determines whether a new note-off has occurred based on the performance depth indicated by the performance signal. Specifically, the controller 11 determines whether the performance depth, which is determined by the detection result obtained by the breath sensor 17, has decreased anew to cross the first threshold THA (whether the time T2 illustrated in FIG. 4 has arrived). It is to be noted that in this embodiment, by way of description, the term note-off is used to indicate a case that the performance depth has decreased anew to cross the second threshold THB (S302) and a case that the performance depth has decreased anew to cross the first threshold THA (S310).

Then, in a case that the controller 11 determines that the performance depth has decreased anew to cross the first threshold THA, the controller 11 advances the procedure to step S311. At step S311, the controller 11 causes “at least one phoneme including the end consonant” (among the phonemes constituting the identified syllable), that is, the remaining phoneme, among the phonemes, that includes the end consonant to start being pronounced. The controller 11 also causes the pronunciation that started at step S307 to end. For example, in a case that the identified syllable is a special syllable “mas”, the controller 11 causes the beginning phoneme [ma] to end being pronounced, and causes the remaining phoneme [s], which is equivalent to the end consonant, to start being pronounced at the time T2 (FIG. 4). Then, the controller 11 ends the processing illustrated in FIG. 7.

In a case that the controller 11 determines that the controller 11 determines that the performance depth has not decreased anew to cross the first threshold THA at step S310, the controller 11 determines whether a new note-off has occurred at step S312. Specifically, the controller 11 determines whether the performance depth, which is determined by the detection result obtained by the breath sensor 17, has decreased anew to cross the second threshold THB (whether the time T3 illustrated in FIG. 4 has arrived).

In a case that the controller 11 determines that the performance depth has not decreased anew to cross the second threshold THB, the controller 11 advances the procedure to step S314 to perform other processing. Then, the controller 11 ends the processing illustrated in FIG. 7. An example of the “other processing” at step S314 is that the controller 11 outputs an instruction to change the pronunciation volume or the pitch based on a change in the obtained performance depth.

In a case that the controller 11 determines that determines that the performance depth has decreased anew to cross the second threshold THB at step S312, the controller 11 advances the procedure to step S313. At step S313, the controller 11 causes “at least one phoneme including the end consonant” (among the phonemes constituting the identified syllable), that is, the remaining phoneme, among the phonemes, that includes the end consonant to end being pronounced.

For example, in a case that the identified syllable is a special syllable “mas”, the controller 11 causes the remaining phoneme [s], which is equivalent to the end consonant, to end being pronounced at the time T3 (FIG. 4). As a result, the pronunciation of the remaining phoneme [s] is continued for the period between the time T2 and the time T3. The period between the time T2 and the time T3 is adjustable by the user adjusting the duration of the user's performance. This allows control over the fading of the remaining phoneme, among the phonemes, that includes the end consonant, thereby expanding the expressive range of the performance.

Once the controller 11 causes the beginning phoneme located at the beginning of the identified syllable to start being pronounced at step S307, the controller 11 substantially continues the pronunciation of the vowel of the beginning phoneme until the controller 11 causes the remaining phoneme to start being pronounced at step S313.

At step S315, the controller 11 sets the flag F to “0” (the flag F=0), and ends the processing illustrated in FIG. 7.

FIG. 8 is a flowchart of Japanese-language processing performed at step S206 illustrated in FIG. 6.

In this processing, there may be a case that the identifier 34 identifies two or more syllables for a single note-on. A setting unique to this processing is “collective pronunciation setting”. For example, the user can make a collective pronunciation setting when the user instructs to reproduce a piece of music. The collective pronunciation setting is that a combination of a plurality of syllables is identified for a single note-on, and only a consonant of an end syllable of the plurality of syllables is pronounced.

For example, as illustrated in FIG. 3, “ma” of M(11) is a single syllable, and “su” of M(12) is another single syllable. The following description is regarding a case that “ma” and “su” are a combination of syllables identified for a single note-on by the collective pronunciation setting. In this case, while the beginning syllable “ma” is pronounced as usual based on a single note-on, the vowel of the end syllable “su” is not pronounced, and only the consonant [s] is pronounced. The instructor 36 causes the beginning phoneme [ma] at the beginning of the syllable “ma” to start being pronounced at a timing corresponding to the note-on. The instructor 36 also causes the consonant [s] of the syllable “su” to start being pronounced at a timing corresponding to the note-off. This processing will be detailed by referring to the flowchart illustrated in FIG. 8.

At steps 401 to 404, the controller 11 performs processings similar to the processings at steps S301 to 304 illustrated in FIG. 301. At step S405, the controller 11 identifies the syllable currently to be pronounced in accordance with the order in which the syllables to be pronounced are identified. There may be a case that a syllable identified in this identifying order corresponds to the beginning syllable of a combination of a plurality of syllables set in the collective pronunciation setting. In this case, the controller 11 identifies, as the syllable currently to be pronounced, the combination of a plurality of syllables including the beginning syllable.

At step S406, the controller 11 determines whether the identified syllable is a combination of a plurality of syllables set in the collective pronunciation setting. In a case that the identified syllable is not a combination of a plurality of syllables set in the collective pronunciation setting, then at step S410, the controller 11 performs processing similar to the processing at step S309. In a case that the identified syllable is a combination of a plurality of syllables set in the collective pronunciation setting, the controller 11 advances the procedure to step S407.

At step S407, the controller 11 causes the beginning phoneme located at the beginning of the beginning syllable of the identified combination of syllables to start being pronounced. That is, the controller 11 causes the identified syllable to start being pronounced excluding the phoneme of the consonant of the end syllable. For example, in a case that “ma” and “su” are a combination of a plurality of syllables set in the collective pronunciation setting, the controller 11 causes the beginning phoneme [ma] at the beginning of the syllable “ma” to start being pronounced (time T1).

At step S408, the controller 11 performs processing similar to the processing at step S308. At steps S417 and S409, the controller 11 performs processings respectively similar to the processings at steps S316 and S317. At steps S411, S413, S415, and S416, the controller 11 performs processings respectively similar to the processings at steps S310, S312, S314, and S315.

At step S412, the controller 11 causes the consonant of the end syllable of the identified syllables to start being pronounced. The controller 11 also causes the pronunciation that started at step S407 to end. For example, in a case that “ma” and “su” are a combination of a plurality of syllables set in the collective pronunciation setting, the controller 11 causes the beginning phoneme [ma] to end being pronounced, and causes the consonant [s] of the syllable “su” to start being pronounced (time T2). Then, the controller 11 ends the processing illustrated in FIG. 7.

At step S414, the controller 11 causes the consonant of the end syllable of the identified syllables to end being pronounced. For example, in a case that “ma” and “su” are a combination of a plurality of syllables set in the collective pronunciation setting, the controller 11 causes the consonant [s] of the syllable “su” to end being pronounced (time T3).

In this embodiment, a note-on or a note-off is determined based on the obtained performance signal (performance information). Then, a syllable corresponding to the timing at which the note-on was identified is identified from the lyrics data. The controller 11 (the instructor 36) causes the identified syllable to start being pronounced at the timing corresponding to the note-on, and causes at least one phoneme among phonemes constituting the identified syllable to start being pronounced at the timing corresponding to the note-off. This enables a syllable to be pronounced as intended by the performer.

In particular, in a case that the language is English and that the identified syllable includes a consonant at the end of the identified syllable, the controller 11 causes the beginning phoneme located at the beginning of the identified syllable to start being pronounced at the timing corresponding to the note-on. The controller 11 also causes the remaining phoneme, among the phonemes, that includes the end consonant to start being pronounced at the timing corresponding to the note-off. Thus, the end consonant, as well as the beginning phoneme, can be pronounced by one operation.

The controller 11 also causes the remaining phoneme to start being pronounced in response to the performance depth decreasing anew to pass (cross) the first threshold THA. The controller 11 also causes the end consonant of the remaining phoneme to end being pronounced in response to the performance depth decreasing anew to pass the second threshold THB. Thus, pronunciation duration of a consonant can be adjusted by a musical performance operation.

In a case that the language is Japanese, the control is performed in a case that a plurality of syllables (such as “ma” and “su”) are identified for a single note-on and set in the collective pronunciation setting. The controller 11 causes the beginning phoneme located at the beginning syllable of the identified syllables to start being pronounced at the timing corresponding to the note-on. The controller 11 also causes the consonant of the end syllable to start being pronounced at the timing corresponding to the note-off. Thus, in a case of Japanese-language lyrics as well, the end consonant, as well as the beginning phoneme, can be pronounced by one operation, and the pronunciation duration of a consonant can be adjusted by a musical performance operation. As a result, a syllable can be pronounced as intended by the performer.

It is to be noted that the “special syllable” that can be processed as described in FIG. 7 will not be limited to “mas”; other examples include “teeth”, “make”, “rice”, “fast”, and “desks”.

There may be a case that two vowels are included in a single syllable. When a “special syllable” includes two vowels, the controller 11 may, at step S307, cause a first vowel of the two vowels and the beginning phoneme, among the phonemes constituting the identified syllable, that is located at the beginning of the identified syllable to start being pronounced. In this case, at step S311, the controller 11 may cause a second vowel of the two vowels and the end consonant to start being pronounced as the remaining phoneme.

For example, in a case of “make”, [me] corresponds to a phoneme excluding the “at least one phoneme including the end consonant” described at step S307, and [i] and [k] correspond to the “at least one phoneme including the end consonant” described at step S311. Specifically, the pronunciation of [me] starts at the time T1, the pronunciation of [me] ends at the time T2, and the pronunciation of [i] starts at the time T2. At the time T3, the pronunciation of [i] ends and [k] is pronounced for a predetermined period of time. It is also possible to cause [i] to be pronounced at the time T2 for a predetermined period of time, then to start the pronunciation of [k], and to end the pronunciation of [k] at the time T3.

It is possible to use a third threshold as a mute control threshold, in addition to the mute control thresholds THA and THB. In this case, the pronunciation of [i] may start at the first threshold THA, the pronunciation of [i] may end at the second threshold THB, the pronunciation of [k] may start at the second threshold THB, and the pronunciation of [k] may end at the third threshold.

In a case of “rice”, which includes two vowels, [ra] corresponds to a phoneme excluding the “at least one phoneme including the end consonant”, and [i] and [s] correspond to the “at least one phoneme including the end consonant”.

It is to be noted that some syllables include two or more consonant phonemes. For example, in a case of “fast”, [fa] corresponds to a phoneme excluding the “at least one phoneme including the end consonant”, and [s] and [t] correspond to the “at least one phoneme including the end consonant”. Among [s] and [t], the pronunciation of [s] starts at the time T2. At the time T3, the pronunciation of the phoneme [s] ends, and [t] is pronounced for a predetermined period of time. It is to be noted that the pronunciation of [t] may start after [s] is pronounced for a predetermined period of time starting from the time T2, and the pronunciation of [t] may end at the time T3.

It is possible to use a third threshold as a mute control threshold, in addition to the mute control thresholds THA and THB. In this case, the pronunciation of [s] may start at the first threshold THA, the pronunciation of [s] may end at the second threshold THB, the pronunciation of [t] may start at the second threshold THB, and the pronunciation of [t] may end at the third threshold.

It is to be noted that some syllables include three or more consonant phonemes (for example, “desks”). In this case, it is possible to use four thresholds to determine the start and end timings of the pronunciation of each consonant phoneme.

It is to be noted that in this embodiment, it is possible to use a single mute control threshold. In this case, it is possible to use, for example, a fixed value for the pronunciation duration of a consonant phoneme.

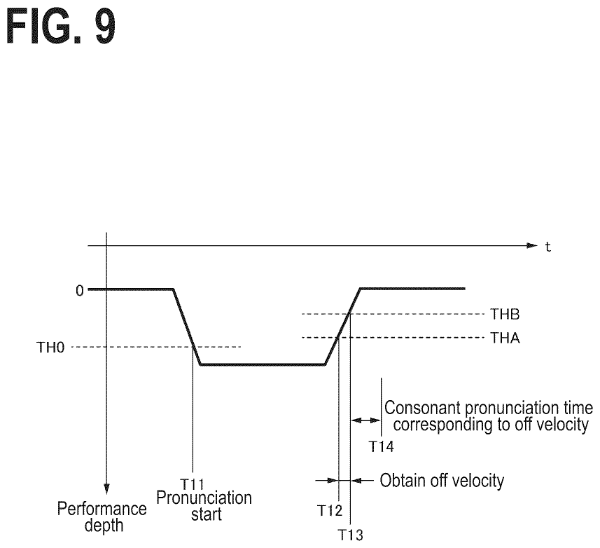

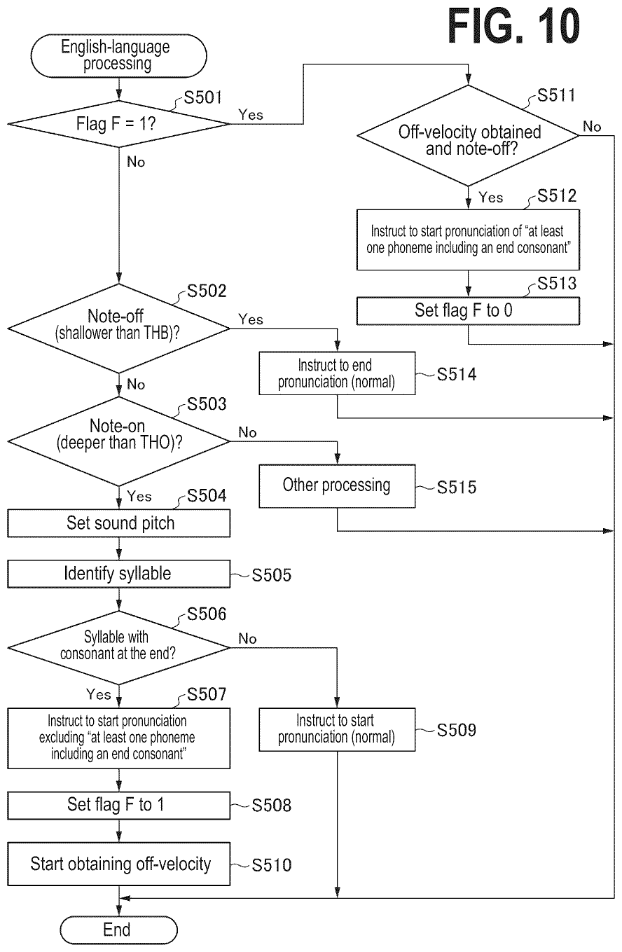

In one embodiment, sound control processing different from the sound control processing according to the previous embodiment may be used. This embodiment will be described by mainly referring to English-language processing illustrated in FIGS. 9 and 10, instead of FIGS. 4 and 7.

FIG. 9 is a timing chart of an example of sound control according to this embodiment performed based on a performance signal. FIG. 10 is a flowchart of English-language processing performed at step S205 illustrated in FIG. 6.

In the previous embodiment, the time from T2 to T3 substantially corresponds to note-off velocity. In the present embodiment, the pronunciation continuation time of the “at least one phoneme including the end consonant” is determined based on an actually obtained note-off velocity.

Referring to FIG. 9, time T11, time T12, and time T13 are defined the same as the time T1 illustrated in FIG. 4, the time T2 illustrated in FIG. 4, and the time T3 illustrated in FIG. 4, respectively. Also, a “special syllable” and a “non-special syllable” used the present embodiment are defined the same as the “special syllable” and the “non-special syllable”, respectively, according to the previous embodiment. Also in present embodiment, thresholds TH0, THA, and THB may be similar to or different from the thresholds TH0, THA, and THB, respectively, according to the previous embodiment. At the time T11, the controller 11 identifies a syllable to be pronounced and causes the syllable to start being pronounced, similarly to the previous embodiment.

The instructor 36 obtains a note-off velocity from the time T12 to the time T13. Based on the obtained note-off velocity, the instructor 36 determines the pronunciation duration of the end consonant of the remaining phoneme (“at least one phoneme including the end consonant”). The determined pronunciation duration is equivalent to the length of the time from T13 to T14. The pronunciation duration may be shorter as the note-off velocity is higher. That is, the pronunciation duration may be shorter as the length of the time from T12 to T13 is shorter. At the time T13, the instructor 36 causes the at least one phoneme including the end consonant to start being pronounced for the determined pronunciation duration (consonant pronunciation start).

For example, in a case of a special syllable “mas”, the controller 11, at the time T11, causes the beginning phoneme [ma] of the special syllable “mas” to start being pronounced. Then, at the time T13, the controller 11 causes the beginning phoneme [ma] to end being pronounced and causes the remaining phoneme [s], which is equivalent to the end consonant, to start being pronounced. At the time T14, the controller 11 causes the remaining phoneme [s] to end being pronounced. Thus, the pronunciation continuation time of [ma] is the time from T11 to T13, and the pronunciation continuation time of [s] (consonant pronunciation time) is the time from T13 to T14.

The processing illustrated in FIG. 10 will be described. At steps S501 to S509, S514, and S515, the controller 11 performs processings respectively similar to the processings at steps S301 to 309, S316, and S317 illustrated in FIG. 7. At step S510, the controller 11 starts obtaining a note-off velocity. Specifically, the controller 11 continues monitoring the performance depth. Then, the controller 11 obtains the time T12 in response to determining that the performance depth has decreased anew to cross the first threshold THA. Then, the controller 11 obtains the time T13 in response to determining that the performance depth has decreased anew to cross the second threshold THB. Upon obtaining the time T13, the controller 11 obtains a note-off velocity based on time difference between the time T13 and the time T12. After step S510, the controller 11 ends the processing illustrated in FIG. 10.

In a case that the controller 11 determines that the flag F=1 at step S501, the controller 11 advances the procedure to step S511. At step S511, the controller 11 determines whether a note-off velocity has been obtained and a new note-off has occurred (that is, whether the performance depth has decreased anew to cross the second threshold THB).

It is to be noted that in the present embodiment, only two thresholds (the first threshold THA and the second threshold THB) are used as mute control thresholds. Therefore, the determination at step S511 is “Yes” since a note-off velocity is obtained in response to the performance depth decreasing anew to cross the second threshold THB.

In a case that the controller 11 determines that a note-off velocity has not been obtained or a new note-off has not occurred at step S511, the controller 11 ends the processing illustrated in FIG. 10. In a case that the controller 11 determines that a note-off velocity has been obtained and a new note-off has occurred, the controller 11 advances the procedure to step S512.

At step S512, the controller 11 determines the pronunciation period of the end consonant (pronunciation duration) of the remaining phoneme based on the obtained note-off velocity. The controller 11 also specifies the determined pronunciation period and causes “at least one phoneme including the end consonant” to start being pronounced. The controller 11 also causes the pronunciation that started at step S507 to end.

For example, in a case that the identified syllable is “mas”, the controller 11 causes [ma] to end being pronounced and at the time T13. Also at the time T13, the controller 11 specifies the time from T13 to T14 as pronunciation period, and causes the remaining phoneme [s], which is equivalent to the end consonant, to start being pronounced. Thus, the pronunciation of [s] ends at the time T14.

At step S513, the controller 11 performs processing similar to the processing at step S315.

It is to be noted that it is possible to use three or more mute control thresholds. In a case that three or more thresholds are used, it is possible to use two of the three thresholds to obtain note-off velocity and to use any one threshold (predetermined threshold) of the three thresholds to determine an occurrence of a new note-off. For example, the controller 11 may obtain a note-off velocity based on time difference between the time when the performance depth crossed the deepest (highest) threshold and the time when the performance depth crossed the second deepest threshold. Then, the controller 11 may cause the remaining phoneme to start being pronounced in response to the performance depth decreasing anew to pass the predetermined threshold (for example, shallowest (lowest) threshold).

The present embodiment enables a syllable to be pronounced as intended by the performer, similarly to the previous embodiment. Additionally, note-off velocity is obtained based on a performance signal, and the pronunciation duration of the end consonant of the remaining phoneme is determined based on the obtained note-off velocity. Thus, the pronunciation duration is determined before detection of the timing to start pronunciation of the end consonant. This reduces the processing load at the start of consonant pronunciation.

It is to be noted that the present embodiment is also applicable to Japanese-language processing.

It is to be noted that in the above-described embodiments, the sound volume may be determined based on note-on velocity. In this case, it is possible to use two or more pronunciation thresholds to determine note-on velocity.

It is to be noted that when the instructor 36 causes pronunciation of at least one phoneme among the phonemes constituting an identified syllable, it is not essential that the phoneme pronounced at the timing corresponding to a note-off includes a consonant. Previously, little consideration was given to the control of syllable pronunciation in response to a note-off. Therefore, even if the phoneme pronounced at the timing corresponding to a note-off does not include a consonant, the effect of causing a syllable to be pronounced as intended by the performer can be obtained by causing at least one phoneme among the phonemes constituting the identified syllable to start being pronounced at the timing corresponding to the note-off.

It is to be noted that the “performance depth”, which is indicated by the performance signal, varies depending on the musical instrument. The sound control device 100 will not be limited to a wind instrument but may be a keyboard instrument. In a case that the sound control device 100 is a keyboard instrument, it is possible to provide a key sensor that detects the stroke position of each key. This key sensor may be used to detect a passing of a position corresponding to each of the thresholds TH0, THA, and THB. There is no particular limitation to the configuration of the key sensor, examples including a pressure sensitive sensor and an optical sensor. In a case of a keyboard instrument, the key position in non-operation state is “0”, and the greater the key depression depth on the keyboard instrument, the deeper the “performance depth” becomes.

It is to be noted that it is not essential for the sound control device 100 to have the functions or form of a musical instrument; the sound control device 100 may be a device capable of detecting pressing operations, such as a touchpad. Additionally, the above-described embodiments are also applicable to smartphones and similar devices capable of obtaining the “performance depth” by detecting the intensity of operations on on-screen controls.

It is to be noted that the performance signal (performance information) may be obtained through communication from an external source. Therefore, the performance operation section 15 may not necessarily be provided.

It is to be noted that in the above-described embodiments, at least part of the functions illustrated in FIG. 3 may be implemented by AI (Artificial Intelligence).

Portions of one embodiment may be combined with portions of another embodiment, as needed.

It is to be noted that the control program described above, represented in software form, can be saved on a storage medium. This allows the program to be loaded into the device according to the above-described embodiment to fulfill its intended functions. This configuration provides effects similar to the effects provided by the present disclosure. In this case, the program's code retrieved from the storage medium fulfill the novel functions. Accordingly, a non-transitory computer readable storage medium storing the code embodies the present disclosure. It will also be understood that the program's code may be supplied through a transmission medium. In this case, the program's code itself embodies the present disclosure. Examples of the storage medium include a ROM, a floppy disk, a hard disk, an optical disk, a magneto-optical disk, a CD-ROM, a compact CD-R, a magnetic tape, and a nonvolatile memory card. The non-transitory computer readable storage medium may be a memory that holds the program for a predetermined period of time. An example of such memory is a volatile memory (for example, a DRAM (Dynamic Random Access Memory)) provided inside a computer system including a server or a client from or to which the program is transmitted via a network such as the Internet or a communication line such as a telephone line.

The above-described embodiments enable a syllable to be pronounced as intended by the performer.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. A sound control device comprising:
an obtainer configured to obtain performance information;
a determiner configured to identify a note-on or a note-off based on the performance information;
an identifier configured to identify, from lyrics data, a syllable corresponding to a timing at which the determiner identified the note-on, the lyrics data including a chronological arrangement of a plurality of syllables to be pronounced; and
an instructor configured to cause the syllable identified by the identifier to start being pronounced at a timing corresponding to the note-on, and configured to cause at least one phoneme among phonemes constituting the identified syllable to start being pronounced at a timing corresponding to the note-off.

2. The sound control device according to claim 1, wherein in a case that the identified syllable includes an end consonant at an end of the identified syllable, the instructor is configured to:
cause a beginning phoneme, among the phonemes, that is located at a beginning of the identified syllable to start being pronounced at the timing corresponding to the note-on; and
cause a remaining phoneme, among the phonemes, that includes the end consonant to start being pronounced at the timing corresponding to the note-off.

3. The sound control device according to claim 2, wherein the instructor is configured to:
cause the remaining phoneme to start being pronounced in response to a performance depth indicated by the performance information decreasing to pass a first threshold; and
cause the end consonant included in the remaining phoneme of the identified syllable to end being pronounced in response to the performance depth decreasing to pass a second threshold, the second threshold corresponding to a second performance depth narrower than a first performance depth corresponding to the first threshold.

4. The sound control device according to claim 2, wherein the instructor is configured to:
obtain a velocity of the note-off based on the performance information; and
based on the obtained velocity, determine a pronunciation duration of the end consonant included in the remaining phoneme of the identified syllable.

5. The sound control device according to claim 4, wherein the instructor is configured to:
obtain the velocity using a plurality of thresholds to be compared with a performance depth indicated by the performance information; and
cause the remaining phoneme to start being pronounced in response to the performance depth decreasing to pass a predetermined threshold among the plurality of thresholds.

6. The sound control device according to claim 1, wherein the note-on comprises a single note-on, and the identifier is configured to identify a single syllable for the single note-on.

7. The sound control device according to claim 2,
wherein the note-on comprises a single note-on, and the identifier is configured to identify a single syllable for the single note-on, and
wherein in a case that the identified single syllable includes an end consonant at an end of the identified single syllable and that the identified single syllable includes two vowels, the instructor is configured to:
cause a beginning phoneme located at a beginning of the single syllable and a first vowel of the two vowels to start being pronounced at the timing corresponding to the note-on; and
cause the remaining phoneme to start being pronounced at the timing corresponding to the note-off, the remaining phoneme including a second vowel of the two vowels and the consonant at the end of the single syllable.

8. The sound control device according to claim 2, wherein the instructor is configured to cause pronunciation of a vowel included in the pronounced beginning phoneme to continue until the instructor causes the remaining phoneme to start being pronounced.

9. The sound control device according to claim 1, wherein the lyrics data includes English-language lyrics.

10. The sound control device according to claim 1, wherein
the lyrics data includes Japanese-language lyrics, and
the note-on comprises a single note-on, and in a case that the identifier identifies a plurality of syllables for the single note-on and that an end syllable among the plurality of syllables is set to be pronounced using only a consonant of the end syllable, the instructor is configured to:
cause a beginning phoneme to start being pronounced at the timing corresponding to the note-on, the beginning phoneme being located at a beginning of a beginning syllable among the plurality of syllables, and
cause the consonant of the end syllable to start being pronounced at the timing corresponding to the note-off.

11. An electronic musical instrument comprising:
the sound control device according to claim 1; and
a musical performance operation section for a user to input the performance information into the sound control device.

12. The electronic musical instrument according to claim 11, wherein
the musical performance operation section comprises a breath sensor configured to detect a pressure change, and
the performance information is obtained based on the pressure change detected by the breath sensor.

13. A non-transitory computer-readable storage medium storing a program which, when executed by at least one processor, causes the at least one processor to:
obtain performance information;
identify a note-on or a note-off based on the performance information;
identify, from lyrics data, a syllable corresponding to a timing of identifying of the note-on, the lyrics data including a chronological arrangement of a plurality of syllables to be pronounced; and
cause the identified syllable to start being pronounced at a timing corresponding to the note-on, and cause at least one phoneme among phonemes constituting the identified syllable to start being pronounced at a timing corresponding to the note-off.

14. A computer-implemented method of controlling a sound control device, the method comprising:
obtaining performance information;
identifying a note-on or a note-off based on the performance information;
identifying, from lyrics data, a syllable corresponding to a timing of identifying of the note-on, the lyrics data including a chronological arrangement of a plurality of syllables to be pronounced; and
causing the identified syllable to start being pronounced at a timing corresponding to the note-on, and causing at least one phoneme among phonemes constituting the identified syllable to start being pronounced at a timing corresponding to the note-off.
